(19) United States
(12) Patent Application Publication
(10) Pub. No.: US 2002/0052915 A1
(43) Pub. Date: May 2, 2002

(54) Network service provider gateway that provides value added services

(76) Inventor: Bahman Amin-Salehi, Santa Rosa, CA (US)

Correspondence Address: Robert S. Babayi, 1600 N. Oak Street, Apt. 1632, Arlington, VA, 22209, US

(21) Appl. No.: 09/814,036

(22) Filed: Mar. 22, 2001

Related U.S. Application Data
(60) Provisional application No. 60/200,148, filed on Apr. 28, 2000.

(51) Int. Cl. G06F 15/16

(52) U.S. Cl. 709/203

(57) ABSTRACT

In accordance with the present invention, a NSP, such as Incumbent Local Exchange Carrier (ILEC) or a Competitive Local Exchange Carrier (CLEC) can own and operate a Value-Added Service (VAS) Gateway. By means of this gateway, the NSP provides its subscribers and customers a unified access interface mechanism for them to access many NSP (or third-party provider) services. According to the invention, the VAS Gateway provides the first-stage of the subscriber's interaction capability with the NSP's domain via a unified user interface for all of the subscriber's on-line information access, data communications, service management, and vertical (value-added) services. For example, the VAS Gateway presents the subscriber with an interactive menu helping the subscriber to select an ISP, transport service or access to his/her corporate network server.

### FIELD OF THE INVENTION

The present invention relates to the field of telecommunications, and more particularly to providing value added services to subscribers of a Network Service Provider (NSP), such as an Incumbent Local Exchange Carrier (ILEC) or a Competitive Local Exchange Carrier (CLEC).

### BACKGROUND OF THE INVENTION

Recent years have witnessed an explosive growth of Internet and on-line applications and services. Ranging from e-commerce, e-mail, e-banking and many other interactive data applications, some of these services or “killer applications” have matured and moved into main stream usage by public at large. Today, users and subscribers can access these applications and other services over the Internet, corporate Intranets, or other public and private networks.

FIG. 1 shows the block diagram of a conventional system for accessing the Internet from an NSP domain. The subscribers use various types of devices, such as PDAs, PCs etc. (herein after referred to as subscriber service devices), to connect to an Internet Service Provider (ISP), such as PSInet, for example, via a modem. Thus, in order to access the Internet from the NSP d region. Often, the Internet Content Providers, ISPs, and NSPs operate as independent entities.

One of the services offered by the Internet Content Providers, such as Yahoo, is Web or Internet Directories, which allow users to search for content or other material on the Web. Such Directories, which use a search engine for performing searches, offer menus with linked access to other Web sites. Table 1 shows a representative example of a menu on existing and commercially available Web directories, such as Yahoo.

Web Directory Menu Example

| E-Mail | White Page Directory | Yellow Page Directory |
|---|---|---|
| Free E-mail address | Phone Number | Businesses by Name |
| w/sub | E-Mail Address | |
| Classified | E-Shopping | E-Banking |
| For Sale | Buy Books | Pay Bills |
| Real-estate | Send card/flower | Account Balance Info. |
| Government Directory | Business Guide | |
| Federal | Companies on-line | |
| State | | |
| Local | | |

As explained above, however, most of the currently available Web directories require the subscribers to establish a link, for example a PPP link over a modem, by going through the NSP domain that serves a defined geography.

NSPs have always been looking for ways to increase revenue by offering various service-related features. For example, NSPs offer call waiting, caller ID, call forwarding, etc., for a monthly service fee. As the market for offering these services mature, NSPs can benefit from providing other value-added services, especially service opportunities offered by the Internetto their subscribers.

### SUMMARY OF THE INVENTION

Briefly, the present invention takes advantage of NSPs position as the first-stage access conduit to the Internet to offer NSP originated applications and services. More specifically, the NSP, which operates the public physical access transmission medium for communicating IP packets to and from a service subscriber device, includes within its access network a server that functions as a Value-Added Service (VAS) Gateway. The public physical access transmission medium can be a twisted pair wire, coaxial cable, optical fiber, or radio frequency spectrum. As such, the NSP can be a wired, wireless, cable, satellite or fiber network service provider and the service subscriber devices can be any kind of a wired or wireless device. In one exemplary embodiment, the IP packets between the service subscriber device and the server are communicated via a NSP router.

The VAS Gateway provides the first stage of user interaction capability with the network. Additionally, the VAS Gateway provides a unified interface to a service subscriber device allowing the subscriber to select one or more NSP services or applications. The subscriber may, for example, use the present invention to choose an ISP, a free phone service provider, a corporate network, etc. The NSP services or applications are selected by manipulating one or more service variables that are associated with the selected NSP services or applications, using this unified interface. For example, the service variables can relate to selecting, changing, or combining the NSP services or applications. Using the manipulated service variables, the service subscriber device accesses the selected NSP services or applications.

According to some of the more detailed features of the present invention, the services or applications can include, among other things, data communications, information access, voice over IP, service management, unified communications, billing, VPN, 800-Data, on-line subscription, conferencing, calling card, unified messaging, transit carrier selection and transport service selection. Moreover, the manipulated service variables can be interdependent and used on a per session basis. According to yet another detailed feature of the present invention, the unified user interface can provide a single password for authenticating access to the plurality of NSP services or applications.

### BRIEF DESCRIPTION OF THE DRAWINGS

FIG. 1 shows a block diagram of a conventional system for accessing the Internet.

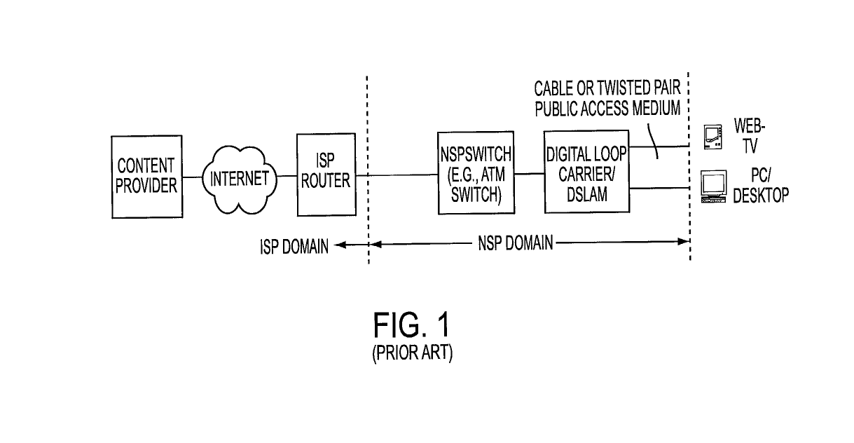

FIG. 2 shows a block diagram of a telecommunication network that implements a VAS Gateway in accordance with one embodiment of the invention.

FIG. 3 shows a block diagram of a telecommunication network that implements the VAS Gateway in accordance with another embodiment of the invention.

FIG. 4 shows a more detailed block diagram of the VAS Server of the invention interfacing with a client user via a NSP Router.

FIG. 5 shows a conceptual block diagram of the VAS Gateway service of the present invention.

### DETAILED DESCRIPTION OF THE PRESENT INVENTION

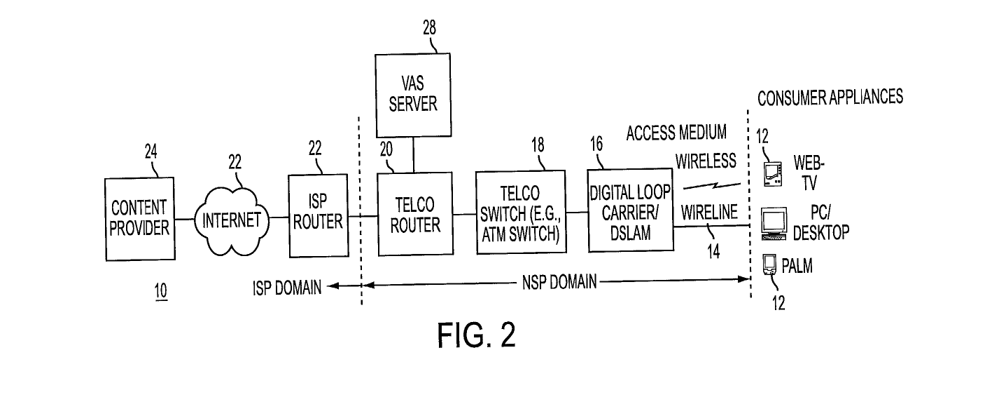

FIG. 2 shows the block diagram of an exemplary system 10 that implements the VAS Gateway. As shown, a number of subscriber service devices 12 communicate information over one or more public transmission mediums 14 that are owned or operated by the NSP. The NSP can be a wired, wireless, cable, satellite or fiber network service provider, a regulated telephone company or provide access to the non-regulated businesses of the NSP as well as ISPs and corporate servers. In the preferred embodiment of the present invention, the information is divided into data packets that are transmitted with a header containing the address of a node where the data packets are sent. In one exemplary embodiment, the data packets comprise IP packets that conform to the Internet Protocol specification. The IP packets can be communicated over a twisted pair wire, coaxial cable, optical fiber, or a radio frequency spectrum.

Over such wired or wireless access medium or link 14, the IP packets pass through a Digital Loop Carrier 6 or a Digital Subscriber Line Access Module (DSLAM) 16 to reach a NSP switch 18, which may for example be an ATM switch or others suitable link layer switch. The NSP switch 18 passes the information content (IP packets) to an NSP operated router 20, which decodes the IP header for routing the IP packet's payload to proper destination. For example, the destination address may correspond to an ISP address in which case the data payload is routed to an ISP router 22. Under this arrangement, the ISP provides the domain for accessing the Internet 24 and Internet content providers 26.

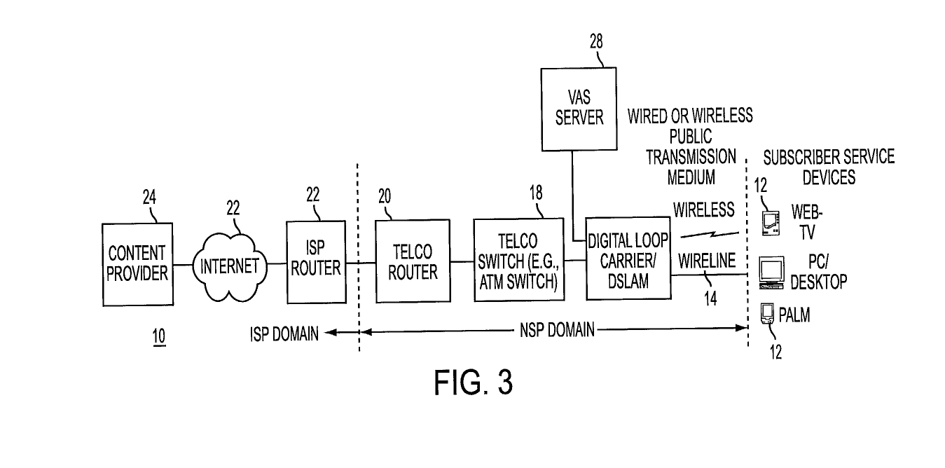

In the exemplary embodiment shown in FIG. 2, a VAS server 28, which acts as a VAS Gateway, is connected to the NSP router 20. In another exemplary embodiment shown in FIG. 3, the VAS server 28 is connected to an edge router, or a Digital Loop Carrier/DSLAM which is equipped with a router 16. The VAS 28 server is used to enable the NSP to provide NSP originated applications and services. More specifically, the VAS Gateway is an IP-based front-end server that mediates access to services and applications offered (directly) by the NSP, or by third-party service providers, via the NSP access network.. The VAS Gateway28 provides a unified access mechanism or interface for the subscriber to gain access to (IP-based) value-added services and applications offered by the NSP, or by a third-party service provider that uses the NSP access network. Such services and applications include but are not limited to: data communications, Voice over IP, service management, billing, information access, and messaging service. The VAS server 28 provides the user with the first-stage of user interaction with the NSP network, followed by service selection capability via a VAS Gateway service menu that is presented to the subscribers on the subscriber access devices 12 for using the NSP, or third party service provider, originated applications and services. Table 2 shows an exemplary menu of potential services that may be offered to the NSP subscribers via the VAS Gateway.

Value-Added Service Gateway Menu Example

| ISP Menu | ISP List | Business Dir. | 800 Data |
|---|---|---|---|
| Telco.net | What ISPs can I | Companies | 1-800-Data |
| Erol | subscribe to? | Departments | |
| PSInet | On-line | LAN | |
| UUNet | subscription | server | |
| AOL | | | |
| IP Phone | Calling Card | Telecom Service | Carrier Dir. |
| Want to place a | Want access (to my | ATM | ILEC |
| call using voice/ | corp. LAN/ISP) | Frame Relay | CLEC |
| IP. | using my calling | IP | IXC |
| | card. | Internet | |
| | | Other | |

Using a subscriber service device 12, a subscriber may interact with the VAS server 28 via the VAS Gateway menu to:

Select an ISP;

Find out about the list of ISPs that may be subscribed to on-line;

Initiate search engines to establish connectivity to a corporate server;

Place an 800 data call;

Gain access to IP telephony;

Place a data call charged to a calling card number;

Select a transport service; and

Select a preferred inter-exchange carrier for the session.

In the preferred embodiment, the present invention uses IP connectivity (e.g., UDP/IP or TCP/IP) between the subscriber service devices 12 and the VAS Server 28. The subscriber service devices 12 can run a HTML application as a client application, for example, an Internet browser or micro-browser. HTTP sessions, such as those described IETF RFC 2068, which is hereby incorporated by reference, may be established between the subscriber service devices 12 and the VAS server 28. In an exemplary embodiment, access control for managing access to the VAS server 28 is defined by IETF RFC 2138 (Remote Authentication Dial In User Service) and draft-ietf-aaa-authz-arch-oo-txt for Authentication, Authorization and Accounting, all of which are hereby incorporated by reference. Also utilized by the present invention is Directory Server, for example that described in IETF RFC 2251 (also known as Lightweight Directory Access Protocol [LDAP]), which is hereby incorporated by reference.

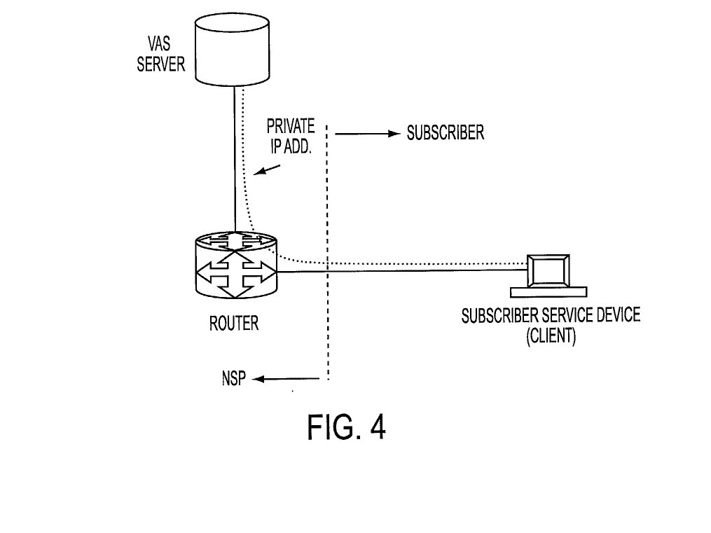

In order for the subscribers to have connectivity with the VAS server 28 to view the VAS Gateway service menu, the subscriber establishes an IP session with the VAS server 28 via the NSP-owned router 20 as shown in FIG. 4. An HTTP session needs to be run over this IP session (HTTP/TCP/IP) between the subscriber device and the VAS server 28. Each subscriber device is assigned a private IP address by the NSP for connectivity to the VAS server 28. Alternatively, to conserve on the number of IP addresses assigned to subscribers, NSP can assign the user an IP address for connectivity to the VAS server dynamically, using IP Configuration Protocol (IPCP) defined in Point to Point Protocol, or Dynamic Host Configuration Protocol (DHCP). IPCP and DHCP are defined by IETF RFC 1332 and DHCP RFC 1531, respectively, both of which are hereby incorporated by reference. When the user has IP connectivity and an HTTP session (HTTP/TCP/IP) with the VAS server, upon selection of a service from the VAS Gateway menu, the VAS server 28 translates the private IP address to another IP address (possibly, a public IP address) as defined in IETF RFC 1631 Network Address Translation protocol (NAT), which is hereby incorporated by reference. This new (translated) IP address is associated with the selected application by the user and is used to locate the application. The application requested may be supported locally on the VAS server, or a separate server. If the application resides on a separate server, that server may be owned by the NSP, or a third-party service provider.

One application of the VAS Gateway is to provide IP Phone service. Upon selection of IP Phone application from the VAS Gateway menu, the VAS server 28 establishes an IP session with a voice/IP gateway. It is assumed that the voice/IP server has a Directory server (e.g., LDAP described in IETF RFC 2251) which would translate a domain name (e.g., jack@ISP1.com) to a public IP address (e.g., 1.24.128.56). One such example is disclosed by Mattaway, et. al. in a U.S. Pat. No. 6,009,469 entitled “Graphic user interface for internet telephony application.”

Yet another application of the VAS Gateway of the invention is to allow subscribers to subscribe to an ISP On-line. If the subscriber has no subscription to an ISP, by selecting an ISP Menu from the VAS Gateway menu, the VAS server 28 presents the subscriber with a list of ISPs to choose from on-line. Selection of an ISP (by a ‘mouse click’) would result in the VAS server 28 to establish an HTTP session between the subscriber and the selected ISP (server).

The VAS Gateway may also be used for providing remote access to corporate LANs. For the ‘work at home’ application of remote access to corporate LAN servers, the VAS server 28 can present the subscriber with a ‘Business Directory’. Using HTTP transactions, the subscriber could make use of the ‘Business Directory’ search engine residing in the VAS server 28, to locate a corporation server, a department, and finally the LAN server through a number of selections (mouse clicks). At any step through this search, the VAS server 28 may prompt the subscriber for authentication, using currently practiced authentication techniques, such as IPSec or alternatively, Authentication, Authorization, and Accounting as described in IETF draft-ietf-aaa-authz-arch-00.txt, which is hereby incorporated by reference. In order to gain access to the corporate server, the subscriber may for example provide a ‘user name’ and ‘password’.

The VAS Gateway may be used to provide ‘800’ or ‘Free Phone’, which has been in practice now for many years. The application of the present invention may also be extended from ‘voice only’ applications to include data and multimedia services as well.

In ‘Free Phone’ application, the subscriber as a session initiator establishes connectivity with a business (or another subscriber) without being billed for the session. Instead, the called party assumes the charges for the communication. Free Phone (e.g., 800 calls) in Telephony makes use of Transaction Capabilities Part (TCAP) of the Signaling System 7 standard (See ITU-T Blue Book, vol. 6, Fascicle VI.8, Geneva, Switzerland, 1989) defined in ITU-T Recommendations Q.771, Q.772, and Q.774, all of which are hereby incorporated by reference. TCAP (defined in ITU-T Rec. Q.771) is a query-response protocol which enables interactions with a database, among other things, to do number translation by the database (e.g., from 800-NXX-XXXX to NPA-NYY-YYYY) or a destination IP address (e.g., XX.XX.XX.XX).

Until now, TCAP has been tied to the lower layer transport layers of the SS7 protocol stack, known as the Message Transfer Part (MTP) defined in ITU-T Recommendation Q.701, which is hereby incorporated by reference. Thus, TCAP and its applications remained specific to narrow-band telephony services. Through recent developments in Telecommunications Industry in defining Application Programming Interfaces (APIs) by JAVA-based AIN (JAIN), an industry initiative led by SUN Microsystems with participation of several telecommunication suppliers and carriers, TCAP can be ported over an IP stack known as TCAP/JAIN-TCAP/UDP/IP. According to this embodiment of the present invention, the VAS server 28 may utilize TCAP/UDP/IP to provide 800′ or ‘Free Phone’ as well as corresponding data and multimedia services.

An additional use of TCAP is an application known as Line Information Database (LIDB) as defined in Telcordia GR-446, the specification of which is hereby incorporated by reference. LIDB translates the calling card number to a billing reference number associated with a user. Thus, the subscriber may establish an instance of communication by first providing an 800number (e.g., 800-NXX-XXXX) and then when prompted by the NSP network, entering a calling card number and his personal identification number. In this manner, a subscriber can have a calling card account billed for this communication. Using technology like JAIN-TCAP, the transport network may be Time Division Multiplexing (TDM) (used currently in the public switched telephone network), Asynchoronous Transfer Mode (ATM), or IP.

Another use of ‘800Data’ is establishment of a multiple party and multimedia conferencing sessions. By the subscriber selecting ‘Conferencing’ application after the ‘800Data’ selection, the VAS server 28 prompts the subscriber for identifying the parties to be joined to the conference session (either by domain name or their network address). A new protocol which is under development in two standards bodies of IETF and ITU-T enables defining a context for an instance of communication. In addition to defining a context for the communication, this protocol, which is known as MEGACO in IETF and H.248 in ITU-T, all incorporated herein by reference, provides the capability for joining multiple parties to the context, thereby supporting conferencing. MEGACO/H.248 is transport technology neutral and can be used in TDM and IP networks. Some recent work in Multi-service Switching Forum has extended the capabilities of MEGACO/H.248 to also support ATM networks.

With the service support provided by one or more NSPs, using the VAS Gateway menu, a subscriber may select the telecommunication service for his application (e.g., access to corporate LAN). As stated earlier, the VAS server first translates the user's private IP address to a public IP address connecting the subscriber to his selected application. Thus, selection of a particular telecommunication service by the subscriber (e.g., ATM) requires the public IP service to set up connectivity via the selected telecommunication service. For ATM, IETF RFC 2225 (Classical IP over ATM), which is hereby incorporated by reference, enables a public IP address belonging to a destination to invoke setting up an ATM switched connection to a destination point.

The VAS Gateway may also be used for carrier selection. Under this embodiment, a subscriber may select a long distance carrier on a call by call (or session by session) basis. To support this application, each long distance carrier (or ISIP) would provide a NSP with a block of public IP addresses specific to the long distance carrier (or ISP). Upon selection of a carrier by the subscriber from the VAS Gateway menu, the Network Address Translation (NAT) function defined by IETF RFC 1631 and IETF RFC 2663, which is hereby incorporated by reference, would translate the user's private IP address to one of the IP addresses in the block of IP addresses provided by the selected long distance carrier (or ISP). The VAS server 28 would use this IP address as the source IP address of the subscriber to connect the subscriber to the selected carrier's server.

The public IP address provided by the long distance carrier (or the ISP) enables the NSP to route the communication exclusively through the selected carrier's network. This method is known as policy source routing and is in contrast to shortest path routing defined by Open Shortest Path First (OSPF) standard (IETF RFC 1131), which is hereby incorporated by reference.

Some if not many of the subscriber selections from the VAS Gateway menu may be inter-dependent. For instance, if a corporate server is served by a single carrier that has only frame relay, selection of the corporate server could by default result in selection of carrier in addition to the transport service, thereby obviating the need for the subscriber to make the latter two selections.

It is contemplated that the NSP may also provide advertising as a source of revenue by also using the VAS gateway as an advertising billboard.

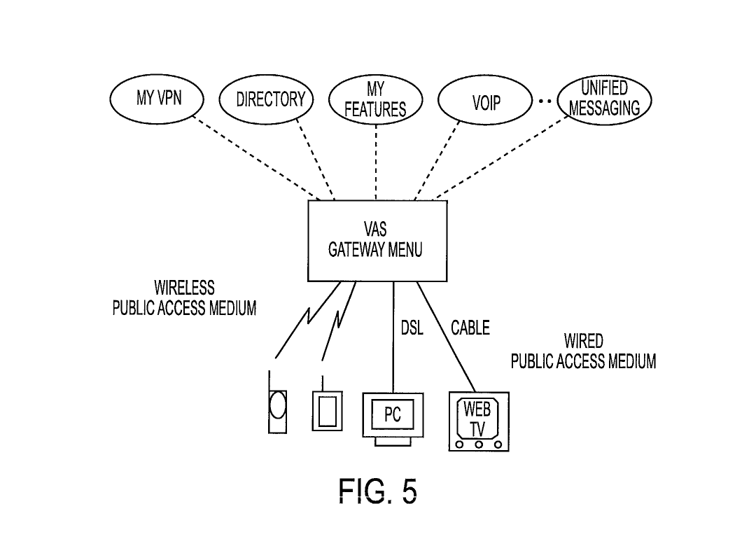

FIG. 5 shows a conceptual diagram for selecting and accessing services and applications offered by the NSP. As shown, the subscriber service devices 12 communicate IP packets over the public physical access transmission medium 14 that is operated by the NSP to access the VAS Gateway menu which offers the users a first stage unified interface to access services and applications. These services and applications may be directly provided by the NSP, or provided by third-party service providers that use the NSP access network.

In one example, the subscriber can view the VAS Gateway menu and make service selections by ‘point and click’ operations using a “mouse”. The subscribers that subscribe to the VAS Gateway service of the invention will first view an icon on the subscriber service devices, which may be any one or combination of a PC, Web-TV, PDA, or Cell Phone, etc. By a ‘point and click’ operation over this icon, the subscriber is presented with the VAS Gateway services menu. Gaining access to the VAS Gateway service menu may require user authentication provided by IPSec technology, as defined by IETF RFC 2410, which is hereby incorporated by reference. Under IPSec technology, the user is prompted to enter his/her user name and password. After the user is successfully authenticated, s/he is presented with the VAS Gateway service menu. Using the VAS Gateway menu, the subscribers can view the offered NSP (and third party provider) services and applications, e.g., VPN, Directory, Features, VOIP, and Unified Messaging. The subscriber can now select and access services and applications that appear on the service menu.

The VAS Gateway menu, which acts as a unified interface, allows the subscriber to manipulate service variables associated with the selected NSP services or applications. For example, the subscriber can select one or more of a Virtual Private Network (VPN), a transport service, inter-exchange carrier, a session payment method, a personal messaging service (e.g., my messages), service management, etc.

The subscribers can then access the selected NSP services or applications, using the manipulated service variables. The service selections may be inter..dependent and may comprise a plurality of services. In this way, the subscribers can be given per session subscription selection flexibility during the use of the services, without having to be locked to selecting services before hand at subscription time. In contrast to prior art systems, in which any changes to or switching between services requires a new service order, the service access method of the invention allows every subscriber communication to be a separate and apart service subscription. Moreover, the subscribers can be assigned a single access and password authentication to gain access to multiple NSP services.

### An Exemplary Virtual Private Networking Application

Virtual Private Networking (VPN) is one of the applications supported by the present invention. VPN, by definition, is a service that uses the public data network. However, it utilizes privacy mechanisms and measures to a secure and ‘virtual’ private network. As a result, each subscriber is assigned a private IP address for communications with the VAS server 28. The privacy for the VPN is enabled by Ipsec which is the state-of-art technology for security in IP communications.

The subscriber may select both the VPN service from the VAS Gateway menu as well as a transport service. Examples of transport service that can be selected include: Asynchronous Transfer Mode (ATM), Multiprotocol Label Switching (MPLS), or IP. In addition, the subscriber may select an inter-exchange carrier (e.g., AT&T, MCI), if the establishment of a session requires using a long-distance carrier. In order to establish the VPN session, the subscriber first locates a desired server, e.g., a corporate server, by selecting the Business Directory from the VAS Gateway menu, followed by additional subsequent selections for ‘Company Name’, ‘Department Name’, and ‘Server Name’. During each step of these selections, the subscriber may be prompted for a user-name and password for authentication before the subscriber may proceed to the next selection. The authentication may also include various authorization levels, whereby not all users could gain access to the more sensitive corporate servers. The subscriber can then select Business Directory, followed by selecting a corporation, a work group, and finally, a corporate server.

After successful completion of authentication, the subscriber is given access to an IP session with its corporate server. This session requires a public IP address belonging to the corporate server, which is used as the IP destination address. The VAS server 28 runs a hierarchical search engine for locating the corporate servers, which have their own IP addresses. Using the Business Directory shown on the VAS Gateway menu, the subscriber locates a desired corporate name. Using LDAP, the VAS server 28 translates the name of the corporate server to its (public) IP address. Next, the VAS server 28 translates the subscriber's private IP address to the corporate server's public IP address (using Network Address Translation, as defined in IETF RFC 1631 and RFC 2663). After selection of the corporate server (IP address location identification) is completed, the VAS Gateway menu can prompt the subscriber to select a transport service between the VAS server 28 and the corporate server.

If the subscriber selects ‘IP’ as the transport service, the VAS server 28, having identified the IP address of the corporate server, establishes an IP session with the corporate server. If the subscriber selects ATM as the transport service, alter identification of the corporate server's IP address, the VAS server employs ‘Classical IP over ATM’ protocol, as defined in IETF RFC 2225, to establish an ATM switched connection (SVC) to the corporate server.

Another transport service supported by the present invention is the MPLS, which is a general purpose tunneling mechanism to carry IP payloads. MPLS uses label switching to forward IP packets through the network. MPLS separates control plane from forwarding plane. MPLS presumes existence of Label Switched Routers (LSRs) in the NSP network. Prior to packet forwarding from source to destination, MPLS signaling distributes label bindings among participating LSRs and forms a link state packet (LSP). MPLS labels may be piggy-backed in RSVP, BGP, or PIM messages. IETF MPLS Working Group has developed a label distribution protocol (LDP) that distributes destination/label mapping for uni-cast destination-based IP routing. RSVP or CR-LDP distribute labels over explicit paths for traffic engineering. LDP runs over TCP and can use MD5 authentication. BGP/MPLS IP VPN is described in IETF Draft-rosen-rfc2547bis-02.txt.

As stated, previously, in addition to transport service selection, the subscriber may also be prompted for selection of an inter-exchange carrier (e.g., MCI), if one is required, or an alternative Local Exchange Carrier. This selection should precede selection of a transport service. It should be noted that if a service provider has only one transport service, selection of a carrier defaults to the only transport service supported by the carrier, thereby skipping the stage for transport service selection by the user.

In a separate application of the VAS Gateway, the user is a craft person or a network operator working for the NSP. The operator can use the VAS Gateway and its service menu for service creation by making proper selections required for network and service provisioning.

What is claimed:

1. A method for accessing services and applications offered by a network service provider (NSP), comprising:
communicating IP packets between a service subscriber device and a server over a public physical access transmission medium that is operated by the NSP;
providing a unified interface to the service subscriber device for selecting one or more NSP services or applications;
manipulating service variables associated with the selected NSP services or applications; and
accessing the selected NSP services or applications, using the manipulated service variables.

2. The method of claim 1, wherein the public physical access transmission medium comprises at least one of a twisted pair wire, coaxial cable, optical fiber, and radio frequency spectrum.

3. The method of claim 1, wherein the plurality of services or applications comprises at least one of data communications, information access, voice over IP, service management, unified communications, billing, VPN, 800-Data, on-line subscription, conferencing, calling card, unified messaging, transit carrier selection; and transport service selection.

4. The method of claim 1, wherein manipulating service variables is associated with selecting, changing, combining the NSP services or applications.

5. The method of claim 1, wherein the variables associated with the plurality of services or applications are interdependent.

6. The method of claim 1, wherein the IP packets between the service subscriber device and the server are communicated via a NSP router.

7. The method of claim 1, wherein the service subscriber device runs a browser interface.

8. The method of claim 1, wherein the service variables are manipulated for the selected NSP service or application per session.

9. The method of claim 1, wherein the unified user interface provides a single password for authenticating access to the plurality of NSP services or applications.

10. The method of claim 1, wherein the servers is a third-party service provider server.

11. The method of claim 1, wherein an IP session is realized by means of a private IP address assigned to the user device by the NSP.

12. The method of claim 1, wherein the IP is assigned by the NSP dynamically using at least one of an IP Configuration Protocol (IPCP) in PPP and Dynamic Host Configuration Protocol.
